(19) United States
(12) Patent Application Publication
(10) Pub. No.: US 2011/0265485 A1
(43) Pub. Date: Nov. 3, 2011

(54) FLUID COOLED INJECTION NOZZLE ASSEMBLY FOR A GAS TURBOMACHINE

(75) Inventors: Lucas John Stoia, Taylors, SC (US); Bryan Wesley Romig, Simpsonville, SC (US)

(73) Assignee: GENERAL ELECTRIC COMPANY, Schenectady, NY (US)

(21) Appl. No.: 12/771,593

(22) Filed: Apr. 30, 2010

(51) Int. Cl. F02C 7/22; F02C 7/14

(52) U.S. Cl. 60/772; 60/740; 239/132.3

(57) ABSTRACT

A turbomachine includes a fluid cooled injection nozzle assembly. The fluid cooled injection nozzle assembly includes an inner conduit portion that includes a body portion having first end portion to a tip end portion. The body portion includes an outer surface and an inner surface. A cooling element extends through the inner conduit portion. The cooling element includes a body element having a first end section that extends to a second end section. The body element includes an outer surface and an inner surface that defines a cooling passage. The outer surface of the body element is spaced from the inner surface of the inner conduit portion to define a return channel. Fluid passing through the cooling passage impinges upon and convectively cools the tip end portion, enters the return channel and is directed out from the nozzle member.

### BACKGROUND OF THE INVENTION

The subject matter disclosed herein relates to the art of turbomachines and, more particularly to a fluid cooled injection nozzle assembly for a gas turbomachine.

In general, gas turbomachine engines combust a fuel/air mixture that releases heat energy to form a high temperature gas stream. The high temperature gas stream is channeled to a turbine via a hot gas path. The turbine converts thermal energy from the high temperature gas stream to mechanical energy that rotates a turbine shaft. The turbine may be used in a variety of applications such as providing power to a pump or an electrical generator.

Currently, there is a need to lower turbomachine emissions. One path to lower emissions lies in eliminating a pilot flame that is currently present at tip portions of a turbomachine nozzle. The pilot flame typically burns at temperatures higher than both primary and secondary flames, which causes increased NOx emissions. By eliminating the pilot flame, a high NOx contributing fuel circuit is removed from the turbomachine.

### BRIEF DESCRIPTION OF THE INVENTION

According to one aspect of the invention, a turbomachine includes a compressor, a turbine, a combustor operatively coupled to the compressor and the turbine, and a fluid cooled injection nozzle assembly mounted in the combustor. The fluid cooled injection nozzle assembly includes a nozzle member including a body having a first end that extends to a second end through an intermediate portion. The body includes an outer surface and an inner surface that defines a hollow interior. An inner conduit portion extends through the nozzle member. The inner conduit portion includes a body portion having first end portion that extends from the first end of the nozzle member to a tip end portion that projects beyond the second end of the nozzle member. The body portion includes an outer surface and an inner surface. A cooling element extends through the inner conduit portion. The cooling element includes a body element having a first end section that extends to a second end section. The body element includes an outer surface and an inner surface that defines a cooling passage. The outer surface of the body element is spaced from the inner surface of the inner conduit portion to define a return channel. Fluid passing through the cooling passage impinges upon and convectively cools the tip end portion and enters the return channel and directed out from the nozzle member.

According to another aspect of the invention, a fluid cooled injection nozzle assembly for a turbomachine includes a nozzle member including a body having a first end that extends to a second end through an intermediate portion. The body includes an outer surface and an inner surface that defines a hollow interior. An inner conduit portion extends through the nozzle member. The inner conduit portion includes a body portion having first end portion that extends from the first end of the nozzle member to a tip end portion that projects beyond the second end of the nozzle member. The body portion includes an outer surface and an inner surface. A cooling element extends through the inner conduit portion. The cooling element includes a body element having a first end section that extends to a second end section. The body element includes an outer surface and an inner surface that defines a cooling passage. The outer surface is spaced from the inner surface of the inner conduit portion to define a return channel. Fluid passing through the cooling passage impinges upon and convectively cools the tip end portion and enters the return channel and directed out from the nozzle member.

According to yet another aspect of the invention, a method of cooling a fluid cooled turbomachine injection nozzle includes guiding a fluid into a nozzle member of the fluid cooled turbomachine injection nozzle, directing a portion of the fluid into a cooling element extending through the nozzle member, passing the portion of the fluid toward of a tip portion of an inner conduit portion of the fluid cooled turbomachine injection nozzle, and leading the portion of the fluid onto a rear surface of the tip portion to establish impingement and convective cooling of the tip portion.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is schematic cross-sectional side view of a turbomachine including a nozzle assembly in accordance with an exemplary embodiment;

FIG. 2 is a cross-sectional view of a combustor portion of the turbomachine of FIG. 1;

FIG. 3 is a cross-sectional view of the nozzle assembly of FIG. 1; and

FIG. 4 is an upper right perspective view of an end portion of the nozzle assembly of FIG. 3.

The detailed description explains embodiments of the invention, together with advantages and features, by way of example with reference to the drawings.

### DETAILED DESCRIPTION OF THE INVENTION

The terms “axial” and “axially” as used in this application refer to directions and orientations extending substantially parallel to a center longitudinal axis of a centerbody of a burner tube assembly. The terms “radial” and “radially” as used in this application refer to directions and orientations extending substantially orthogonally to the center longitudinal axis of the centerbody. The terms “upstream” and “downstream” as used in this application refer to directions and orientations relative to an axial flow direction with respect to the center longitudinal axis of the centerbody.

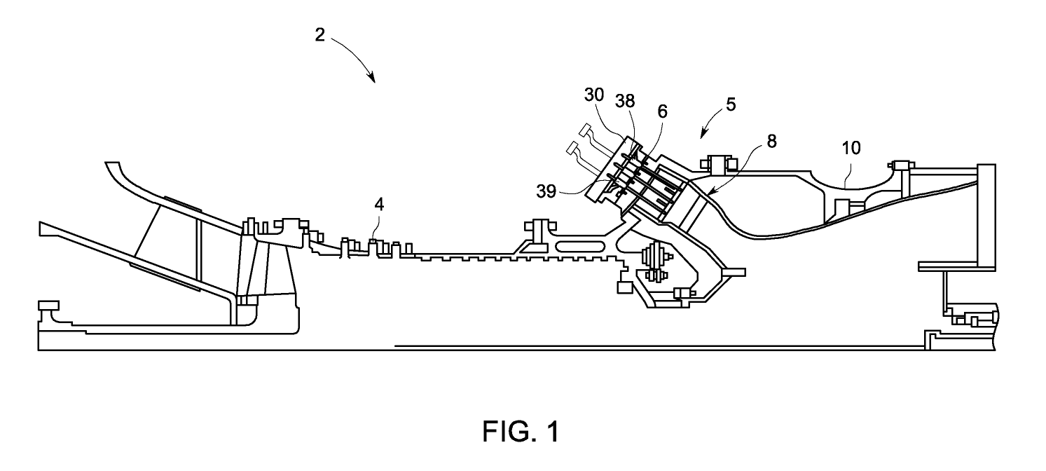

With reference to FIG. 1, a turbomachine constructed in accordance with an exemplary embodiment is indicated generally at 2. Turbomachine 2 includes a compressor 4 and a combustor assembly 5 having at least one combustor 6 provided with a fuel nozzle or injector assembly housing 8. Turbomachine 2 also includes a turbine 10. Notably, the disclosed exemplary embodiments described herein may be incorporated into a variety of turbomachines. Turbomachine 2 shown and described herein is just one exemplary arrangement.

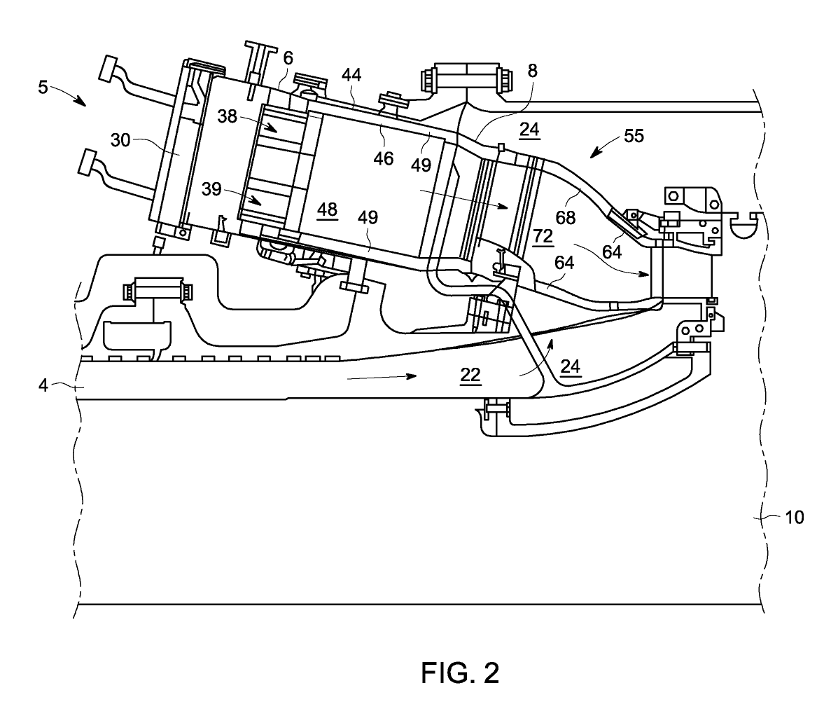

As best shown in FIG. 2 combustor 6 is coupled in flow communication with compressor 4 and turbine 10. Compressor 4 includes a diffuser 22 and a compressor discharge plenum 24 that are coupled in flow communication with each other. Combustor 6 includes an end cover 30 positioned at a first end thereof. As will be discussed more fully below, end cover 30 provides structural support to a plurality of fluid cooled fuel or injection nozzle assemblies 38 and 39. By fluid cooled injection nozzle assembly, it should be understood that at least injection nozzle assemblies 38 and 39 are cooled using a fluid such as fuel and/or air. Combustor 6 is also shown to include a combustor casing 44 and a combustor liner 46.

As shown, combustor liner 46 is positioned radially inward from combustor casing 44 so as to define a combustion chamber 48. An annular combustion chamber cooling passage 49 is defined between combustor casing 44 and combustor liner 46. A transition piece 55 couples combustor 6 to turbine 10 (FIG. 1). Transition piece 55 channels combustion gases generated in combustion chamber 48 downstream towards a first stage turbine nozzle (not shown). Towards that end, transition piece 55 includes an inner wall 64 that defines a guide cavity 72 that extends between combustion chamber 48 and turbine 10.

During operation, air flows through compressor 4 and compressed air is supplied to combustor 6 and, more specifically, to injector assemblies 38 and 39. At the same time, fuel is passed to injector assemblies 38 and 39 to mix with the air and form a combustible mixture. The combustible mixture is channeled to combustion chamber 48 and ignited to form combustion gases. The combustion gases are then channeled to turbine 10 where thermal energy from the combustion gases is converted to mechanical, rotational energy.

At this point it should be understood that the above-described construction is provided for the sake of completeness and to facilitate a better understanding of exemplary embodiments, which are directed to the structure of injection nozzle assemblies 38 and 39. However, as each injection nozzle assembly 38, 39 is similarly formed, a detailed description will follow referencing injection nozzle assembly 38 with an understanding the injection nozzle assembly 39 includes similar structure.

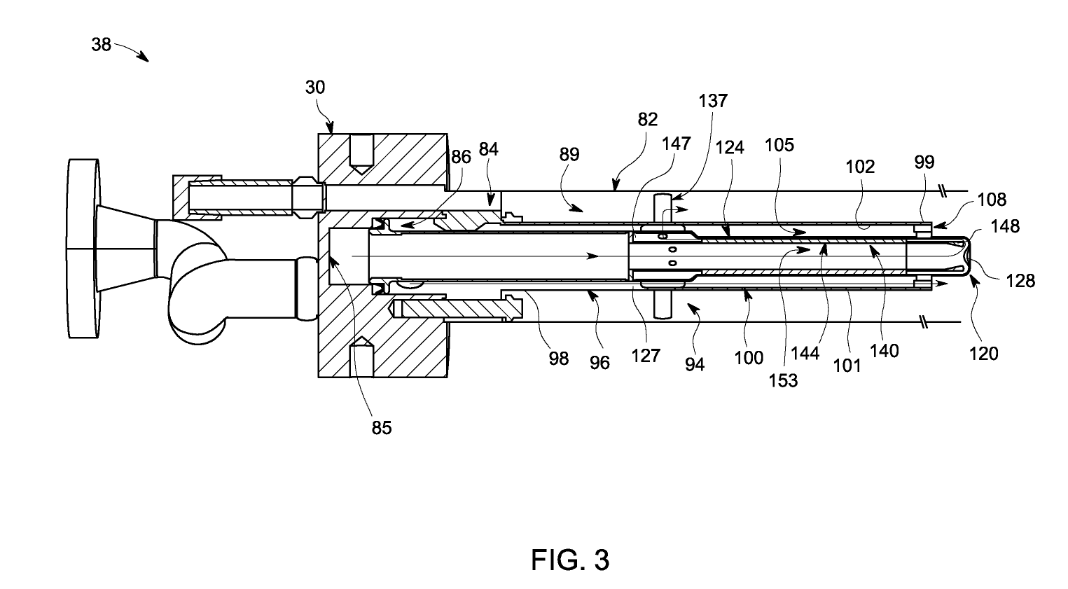

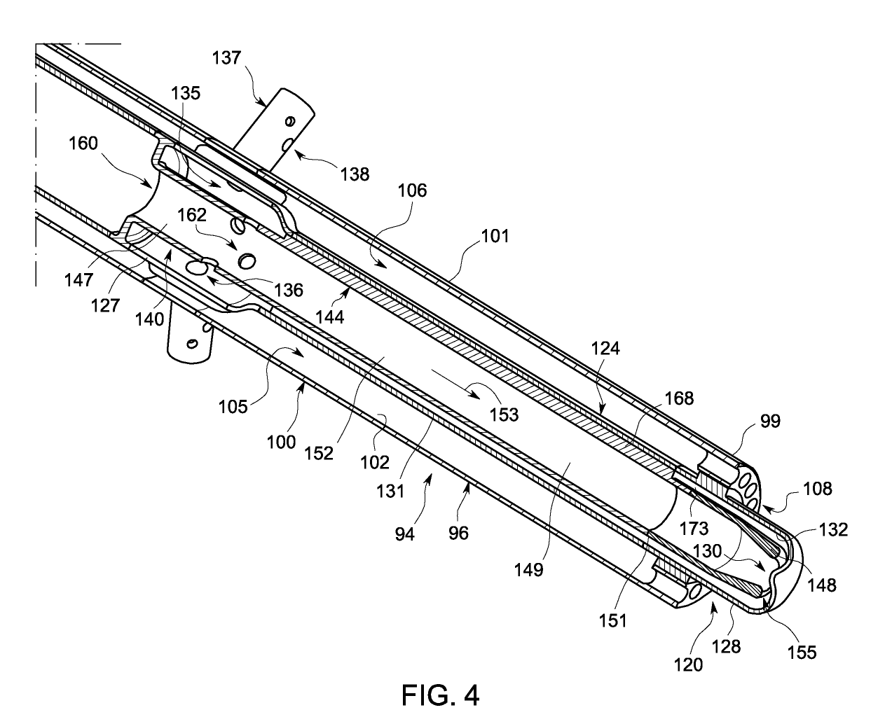

As shown in FIGS. 3 and 4, injection nozzle assembly 38 includes a centerbody 82 which houses a secondary air circuit 84, a secondary fuel circuit 85, and a transfer circuit 86. Centerbody 82 includes a secondary mixing zone 89 in which fuel and air are mixed prior to being injected into combustion chamber 48. In the exemplary embodiment shown, injection nozzle assembly 38 includes a nozzle member 94 arranged within centerbody 82. Nozzle member 94 houses secondary circuit 85 and transfer circuit 86 and includes a body 96 having a first end 98 that extends to a second end 99 through an intermediate portion 100. Body 94 includes an outer surface 101 and an inner surface 102 that establishes a hollow interior 105. Hollow interior 105 defines a purge air passage 106 having a plurality of outlets 108 arranged at second end 99.

In further accordance with the exemplary embodiment, injection nozzle assembly 38 includes an inner conduit portion 120 arranged within hollow interior 105 of nozzle member 94. Inner conduit portion 120 includes a body portion 124 having a first end portion 127 that extends to a second or tip end portion 128. Tip end portion 128 is supported within a hub portion (not shown) of a swirler member (also not shown). In accordance with the exemplary embodiment, tip end portion 124 is sealed thereby establishing injection nozzle assembly 38 as a fluid cooled injection nozzle. Tip end portion 124 includes a guide feature 130 which, as will be discussed more fully below, redirects fluid passing through injection nozzle assembly 38. Body portion 124 is also shown to include an outer surface 131 and an inner surface 132. Inner surface 132 defines, in part, a plenum 135 at first end portion 127. Plenum 135 includes a plurality of outlet members, one of which is indicated at 136, which lead to secondary mixing zone 89. More specifically, outlet members 136 are fluidly connected to a plurality of fuel pegs 137. Fuel pegs 137 are, in turn, fluidly connected to plenum 135 and extend between outer surface 101 of nozzle member 94 and an inner surface (not separately labeled) of centerbody 82. Fuel pegs 137 include a number of exit ports 138 that open to secondary mixing zone 89. With this arrangement, fluid, typically fuel, passing into nozzle member 94 is directed outward to secondary mixing zone 89.

In still further accordance with an exemplary embodiment, injection nozzle assembly 38 includes a cooling element 140 that passes within inner conduit portion 120. Cooling element 140 includes a body element 144 having a first end section 147 that extends to a second end section 148 through an intermediate portion 149 having an outer surface 151 and an inner surface 152 that defines a cooling passage 153 having an outlet section 155. Cooling element 140 includes an inlet 160 for receiving fluid, typically fuel, and a plurality of outlets 162. As will be discussed more fully below, outlets 162 guide fluid to plenum 135. Outer surface 151 of cooling element 140 is spaced from inner surface 132 of inner conduit portion 120 by a plurality of supports, one of which is indicated at 168. Supports 168 establish a return channel 173 between cooling element 140 and inner conduit portion 120. Return channel 173 leads axially along injection nozzle assembly 38 from tip end portion 128 to plenum 135.

In accordance with the exemplary embodiment, fluid enters inlet 160. A first portion of the fluid passes through outlets 162 and directly to secondary mixing zone 89 via plenum 135 and fuel pegs 137. A second portion of the fluid passes along cooling passage 153 toward tip end portion 128. The second portion of the fluid impinges upon guide feature 130 establishing impingement and convective cooling for tip portion 128. Guide feature 130 also redirects the second portion of the fluid into return channel 173. The second portion of the fluid passes through return channel 173 and into plenum 135. The second portion of the fluid then joins the first portion of the fluid exiting through fuel pegs 137 into secondary mixing zone 89.

At this point it should be understood that exemplary embodiments provide a fluid cooled injection nozzle assembly for a turbomachine that includes a cooling element configured to reduce temperatures at tip end portion 128. The removal of the pilot circuit not only results in a significant cost savings, but also a substantial reduction in emissions. More specifically, the elimination of the pilot circuit leads to a substantial reduction in plumbing, control valves and other associated control functions, but also removes a fuel circuit that produces considerable levels of NOx emissions. The pilot circuit is then replaced with a cooling element that maintains temperatures at the tip end portion at levels which lead to prolonged component life cycle.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A turbomachine comprising:
a compressor;
a turbine;
a combustor operatively coupled to the compressor and the turbine; and
a fluid cooled injection nozzle assembly mounted in the combustor, the fluid cooled injection nozzle assembly including:
a nozzle member including a body having a first end that extends to a second end through an intermediate portion, the body including an outer surface and an inner surface that defines a hollow interior;
an inner conduit portion extending through the nozzle member, the inner conduit portion including a body portion having first end portion that extends from the first end of the nozzle member to a tip end portion that projects beyond the second end of the nozzle member, the body portion including an outer surface and an inner surface; and
a cooling element extending through the inner conduit portion, the cooling element including a body element having a first end section that extends to a second end section, the body element including an outer surface and an inner surface that defines a cooling passage, the outer surface of the body element being spaced from the inner surface of the inner conduit portion to define a return channel, wherein fluid passing through the cooling passage impinges upon and convectively cools the tip end portion, enters the return channel and is directed out from the nozzle member.

2. The turbomachine according to claim 1, wherein the fluid cooled injection nozzle assembly includes a fluid inlet, the fluid inlet being fluidly connected to the first end section of the body element.

3. The turbomachine according to claim 2, wherein the fluid cooled injection nozzle assembly includes an outlet member arranged at the first end portion of the inner conduit portion.

4. The turbomachine according to claim 3, wherein the outlet member extends through the nozzle member.

5. The turbomachine according to claim 2, wherein the cooling element includes an outlet fluidly linked to the outlet member.

6. The turbomachine according to claim 5, wherein the outlet is arranged at the first end section of the body element.

7. The turbomachine according to claim 1, wherein the cooling element includes an outlet section arranged at the second end of the body element, the outlet section being fluidly connected to the return channel.

8. The turbomachine according to claim 1, wherein the tip end portion of the inner conduit portion is sealed.

9. The turbomachine according to claim 8, wherein the tip end portion includes a guide feature exposed to the cooling passage, the guide feature directing cooling fluid from the cooling passage toward the return channel.

10. The turbomachine according to claim 1, wherein fluid cooled injection nozzle assembly includes a purge air passage arranged between the outer surface of the body portion and the inner surface of the body.

11. A fluid cooled injection nozzle assembly for a turbomachine comprising:
a nozzle member including a body having a first end that extends to a second end through an intermediate portion, the body including an outer surface and an inner surface that defines a hollow interior;
an inner conduit portion extending through the nozzle member, the inner conduit portion including a body portion having first end portion that extends from the first end of the nozzle member to a tip end portion that projects beyond the second end of the nozzle member, the body portion including an outer surface and an inner surface; and
a cooling element extending through the inner conduit portion, the cooling element including a body element having a first end section that extends to a second end section, the body element including an outer surface and an inner surface that defines a cooling passage, the outer surface being spaced from the inner surface of the inner conduit portion to define a return channel, wherein fluid passing through the cooling passage impinges upon and convectively cools the tip end portion and enters the return channel and directed out from the nozzle member.

12. The fluid cooled injection nozzle assembly according to claim 11, further comprising: a fluid inlet, the fluid inlet being fluidly connected to the first end section of the body element.

13. The fluid cooled injection nozzle assembly according to claim 12, wherein the nozzle assembly includes an outlet member arranged at the first end portion of the inner conduit portion.

14. The fluid cooled injection nozzle assembly according to claim 13, wherein the cooling element includes an outlet fluidly linked to the outlet member.

15. The fluid cooled injection nozzle assembly according to claim 11, wherein the cooling element includes an outlet section arranged at the second end section of the body element, the outlet section being fluidly connected to the return channel.

16. The fluid cooled injection nozzle assembly according to claim 11, wherein the tip end portion of the inner conduit portion is sealed.

17. The fluid cooled injection nozzle assembly according to claim 16, wherein the tip end portion includes a guide feature exposed to the cooling passage, the guide feature directing cooling fluid from the cooling passage toward the return channel.

18. The fluid cooled injection nozzle assembly according to claim 11, wherein nozzle assembly includes a purge air passage arranged between the outer surface of the body portion and the inner surface of the body.

19. A method of cooling a fluid cooled turbomachine injection nozzle, the method comprising:
guiding a fluid into a nozzle member of the fluid cooled turbomachine injection nozzle;
directing a portion of the fluid into a cooling element extending through the nozzle member;
passing the portion of the fluid toward of a tip end portion of an inner conduit portion of the fluid cooled turbomachine injection nozzle; and
leading the portion of the fluid onto a rear surface of the tip end portion to establish impingement and convective cooling of the tip end portion.

20. The method of claim 19, further comprising:
guiding the portion of the fluid from the rear surface of the tip end portion into a return channel;
flowing the portion of the fluid along an outer surface of the cooling element; and
discharging the portion of the fluid into a combustor of the turbomachine.
